(19) United States
(12) Patent Application Publication
(10) Pub. No.: US 2004/0015404 A1
(43) Pub. Date: Jan. 22, 2004

(54) Method and media for secured desktop printing

(76) Inventor: Brian R. McCarthy, Anaheim Hills, CA (US)

Correspondence Address: SPYROS J. LAZARIS, ESQ., OPPENHEIMER WOLFF & DONNELLY LLP, Suite 3800, 2029 Century Park East, Los Angeles, CA, 90067, US

(21) Appl. No.: 09/973,485

(22) Filed: Oct. 5, 2001

Related U.S. Application Data
(60) Provisional application No. 60/238,831, filed on Oct. 6, 2000.
(60) Provisional application No. 60/201,234, filed on May 1, 2000.

(51) Int. Cl. G06F 7/00

(52) U.S. Cl. 705/26

(57) ABSTRACT

A method of printing a certificate purchased online, such as a printed ticket, directions, a food coupon, a parking pass, a merchandise coupon or other types of certificates, may include purchasing at least one certificate across a computer network and printing the certificate onto the media using a desktop printer. The media may be a sheet having a plurality of separate printing areas separated by lines of weakness. In one embodiment of the media, a sheet has equally-sized printing areas separated into rows and columns by lines of weakness. In another embodiment of the invention, a consumer purchases one or more tickets across a computer network, and then prints the ticket or tickets using a desktop printer. The ticket may be printed onto a media having a ticket printing area defined on at least one edge by a line of weakness. In a particular way of implementing this embodiment, purchasing a ticket across a computer network can further include providing ticket selection information across the network from a computer and transmitting ticket printing information across the network back to the computer.

### CROSS-REFERENCE To RELATED APPLICATIONS

This patent application is related to, and claims the benefit of, U.S. Provisional Patent Application No. 60/238,831, which was filed on Oct. 6, 2000 and which is Entitled METHOD AND MEDIA FOR SECURED DESKTOP PRINTING. This application is also related to U.S. Provisional Patent Application No. 60/201,234, which was filed on May 1, 2000 and which is Entitled SYSTEM AND METHOD FOR GENERATING CUSTOMIZED AND/OR PERSONALIZED DOCUMENTS. U.S. Provisional Patent Application No. 60/238,831 and U.S. Provisional Patent Application No. 60/201,234 are hereby incorporated by reference.

### BACKGROUND OF THE INVENTION

1. Field of the Invention

The present invention relates to event tickets and, in particular, to tickets that may be printed from a personal computer.

2. General Background and State of the Art

Event tickets have been used for generations as a means for gaining access to a wide variety of events. Traditionally, the purchaser purchased a ticket in person from a ticket window. The ticket was pre-printed with particular information such as a seat number and a purchase price. Occasionally, the ticket was printed at the time of purchase and handed to the purchaser.

The process of purchasing tickets at a ticket window has a number of drawbacks. Lines are often long, and the purchaser may spend several minutes or longer standing in line. When the user reaches the front of the line, he may find that the event is sold out, or that his preferred day and time are no longer available. If the purchaser is buying the ticket in advance, he must make an extra trip simply to purchase the ticket, and/or stand in line at the will-call line.

To simplify the process of purchasing tickets, organizations such as TicketMaster have long sold tickets over the telephone. The purchaser typically provides her credit card number over the phone, and the ticket agency transmits the printed ticket to the purchaser by mail. This approach is much more convenient than purchasing the tickets in person, but it is often more expensive due to service and postage charges.

More recently, some companies have started to sell tickets online over the Internet. The purchaser will typically enter various information onto an interactive form on her or his personal computer. The user also provides payment information, such as a credit card. When the order is accepted, an electronic ticket is generated. The user prints the electronic ticket on the desktop printer that is attached to the personal computer. At present, these “tickets” consists of printouts on full-sized sheets of paper. The “tickets” are essentially 8½ by 11″ sheets of paper bearing some form of identifying indicia, such as a bar code. The purchaser presents the full page at the event, where it is scanned by a bar code or other reader to verify the authenticity of the ticket.

These new types of Internet-ordered tickets are more convenient than traditional tickets in that they can be purchased at any time of night or day, and can be printed immediately on a home printer. The “tickets” have the disadvantage, though, of lacking the “look and feel” of a traditional ticket. For example, a traditional ticket typically has a ticket “stub” that the user can retain as a memento. Home-printed tickets lack such a stub. Home-printed tickets also lack a certain aesthetic value as, for example, when one wishes to present the ticket as a gift. A full-sized printed sheet is not as pleasing to receive as a small ticket tucked inside a gift card.

Similar issues arise when purchasing and printing other printable items over a network, such as gift certificates and coupons. As with tickets, gift certificates and coupons can be printed from off of the Internet. However, gift certificates and coupons are typically printed on regular-sized sheets of paper. If the user wishes to separate the certificate or coupon from the sheet, he or she must generally use scissors, which is time consuming.

### INVENTION SUMMARY

One embodiment of the present invention relates to printing an event ticket on a desktop printer. A “desktop” printer can include any of a variety of printers that is typically found in the home or office, such as an ink jet, laser, thermal label or impact printers. A consumer purchases one or more tickets across a computer network, and then prints the ticket or tickets using a desktop printer. The ticket may be printed onto a media having a ticket printing area defined on at least one edge by a line of weakness. In a particular way of implementing this embodiment, the step of purchasing a ticket across a computer network can further include providing ticket selection information across the network from a computer and transmitting ticket printing information across the network back to the computer.

The method may include various features. For instance, the step of printing the ticket may include printing a unique identifier on the media to authenticate the ticket. The unique identifier may be a bar code, alphanumeric printed text, a glyph, an ink pattern or other identification printing known in the art.

In one embodiment, the media includes a removable ticket stub area, and the method further includes the step of printing a ticket stub onto the ticket stub area. Indicia such as directions, a parking pass or a concession coupon may also be printed on the media. The media may include a removable label, and the label may be printed in the printing step. The media may also include a card area having at least one printing surface and a lamination member attached to the media. The lamination member may be adapted to laminate the card area after printing.

Another embodiment of the invention relates to printing gift certificates. A method of printing a gift certificate on a desktop printer may include purchasing a gift certificate across a computer network; and printing the gift certificate using a desktop printer. The gift certificate is printed onto a media having a certificate printing area defined on at least one edge by a line of weakness.

The step of purchasing a gift certificate across a computer network further include providing gift certificate selection information across the network from a computer, and transmitting gift certificate printing information across the network to the computer.

The step of printing the gift certificate may include printing a unique identifier on the media to authenticate the gift certificate. The unique identifier may be a bar code, alphanumeric printed text, a glyph, or another type of identifier known in the art. The method may further include the step of printing gift certificate redemption instructions, or a personalized message on a portion of the media. The media may optionally include a removable card area having a fold line, and the card area can be printed during the printing step. The media may also include a removable envelope seal that may have a printing surface onto which the printer can print.

A third embodiment of the invention relates to a method of printing onto a universal event ticket media. A method of printing a certificate purchased online (such as a printed ticket, directions, a food coupon, a parking pass, or a merchandise coupon) may include the steps of purchasing at least one certificate across a computer network and printing the certificate onto the media using a desktop printer. The media may be a sheet having a plurality of separate printing areas separated by lines of weakness. In one embodiment of the media, a sheet has equally-sized printing areas separated into rows and columns by lines of weakness.

A method of printing media may include printing a ticket on at least one of the printing areas, and printing a ticket stub on an adjacent one of the printing areas.

Another embodiment of the present invention relates to a method for generating and printing customized documents in a system having a first computer communicable with a network and a second computer communicable with the network. The method includes displaying an interactive form on the first computer, entering user information onto the interactive form, transmitting the user-defined information from the first computer to the second computer over the network, obtaining default document parameters from a template file, formulating instructions to a page description file builder based upon the default document parameters and the user-defined information, and building a page description file based upon said instructions. The page description file is transmitted to the first computer, and the page description file is rendered for the first time at the first computer. The rendered page description file is printed onto specialized media comprising at least one removable printable area. The removable printable area on the specialized media is defined on at least one edge by a line of weakness.

Printing the rendered page description file may also include printing a ticket that bears a unique identifier to authenticate the ticket. The unique identifier is at least one of a bar code, alphanumeric printed text or a glyph. The media may also include a removable ticket stub area, and the method may also include printing a ticket stub onto the ticket stub area. The method may also include printing at least one of directions, redemption instructions, a parking pass, merchandise coupon and a concession coupon on the media. A removable label may also be included, the method further including printing onto the removable label. In another embodiment, the media includes a card area comprising at least one printing surface and a lamination member attached to the media and adapted to laminate the card area, with the method further including printing onto the card area. The method may also include purchasing a redemption document by transmitting purchasing information from said first computer to said second computer.

Still another embodiment of the present invention relates to a method of generating customized documents using a processing server, the method including receiving information via a network from a user, processing a purchase order received from the user, obtaining a document template that defines default attributes of a document to be printed, generating a unique identifier associated with said document to be printed, formulating a set of instructions to a page description file builder, said instructions instructing the page description file builder to build a document based upon a combination of said default attributes of the document to be printed, said document customization information, said document personalization information, and said unique identifier, building a page description file from said set of instructions with the page description file builder, and transmitting said page description file to a recipient, wherein the server is programmed to build the page description file without rendering a graphic. The unique identifier is one of the group constituting a serial number, a bar code, a glyph or an ink pattern. The document to be printed includes one of a ticket or a gift certificate.

The present invention has various other aspects and features, which will become apparent in the Detailed Description, the Drawings, and the claims.

### BRIEF DESCRIPTION OF THE DRAWINGS

FIG. 1 is a view of an adaptable universal ticket media with numerous printing areas defined by lines of weakness;

FIG. 2 is a layout for printing several tickets and stubs on the adaptable universal ticket media of FIG. 1;

FIG. 3 is a layout for printing tickets, stubs, coupons and a parking pass on the adaptable universal ticket media of FIG. 1;

FIG. 4 is a layout for printing tickets, ticket stubs and coupons of different configurations on the adaptable universal ticket media of FIG. 1;

FIG. 5 is a layout for printing tickets, ticket stubs, driving directions, a food coupon and a floor plan for a trade show on the adaptable universal ticket media of FIG.

FIG. 6 is a perforated media for printing a ticket, a ticket stub, driving directions, a concession coupon and a card with a removable label;

FIG. 7 is a perforated media having a ticket, a ticket stub, and an assembly for printing a laminated card;

FIG. 8 is a perforated media for printing a gift certificate, instructions for redeeming the gift certificate, a personalized message, and an envelope seal;

FIG. 9 is a perforated media for printing a gift certificate, a personalized card, and a list of stores in a particular area;

FIG. 10 is a flowchart of one method of the invention for generating and printing documents over a network; and

FIG. 11 is a block diagram of a method of the invention for generating and printing a customized and/or personalized document in which the customization and/or personalization information is transmitted from a server on which it is stored to a second server that generates a page description file.

### DETAILED DESCRIPTION OF THE PREFERRED EMBODIMENTS OF THE INVENTION

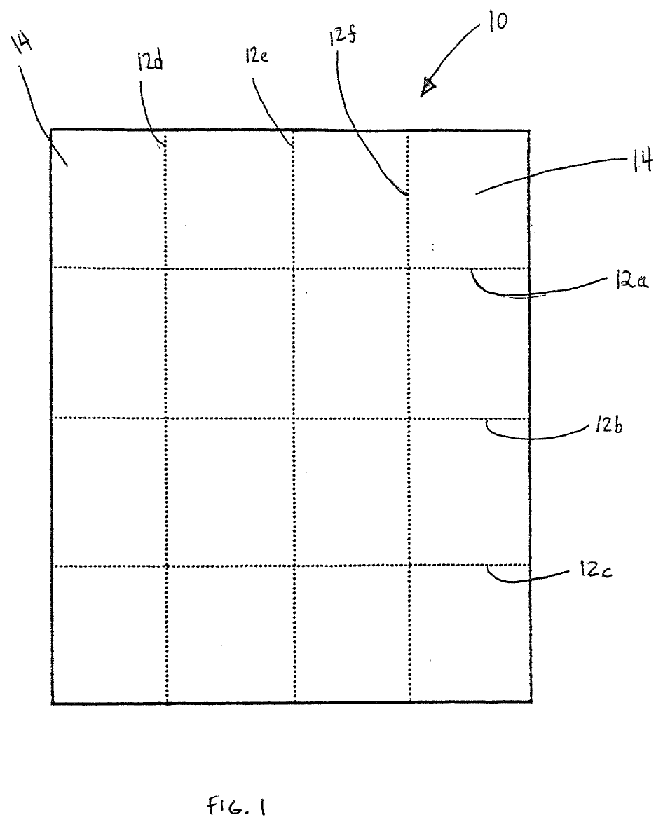

One aspect of the present invention relates to a method and an adaptable assembly for printing tickets and other types of documents. Referring to FIG. 1, a sheet 10 is divided by lines of weakness 12a-f into individual printable areas 14. The lines of weakness are typically perforations or micro-perforations, but may alternatively be score lines on one or both sides of the sheet, partial die cuts, or other types of lines of weakness known in the art.

For example, the line of weakness can be a continuous cut, a perforated cut, a micro-perforated cut, a scoring cut, a slitting cut, or a die cut. The die cut can be a cylinder-profile die cut or a flat-die cut. The cut may be made using mechanical cutting techniques, or alternatively via laser cutting. Good die-cutting is indicated by an easy and clean separation along the die cut. The edge of a separated paper or cardstock portion exhibiting good die-cutting looks clean and does not show signs of a roughened edge, fuzziness and stretching.

When a line of weakness is cut via laser cutting, a laser is employed to make the cuts. A control device controls the power level of the laser to selectively make cuts in a moving web. To cut a perforation, the control device controls the pulse period of the laser to cut a series of alternating cuts and ties. The power level of the laser is pulsated so that the laser is briefly powered to cut through the moving web to form a cut, but is then briefly de-powered to stop cutting and to form a tie.

In one embodiment of the invention, the lines of weakness are “microperforations,” which are particularly well-suited to leave a smooth edge after separation. That is, when a user tears along a micro-perforated line of weakness, the edges at the tear are substantially smooth as compared to traditional perforations. Generally speaking, “micro-perforations” refer to a series of small cuts and ties that are closely spaced together. The micro-perforations can typically be separated by applying nominal pressure along the perforations.

In one example of micro-perforations, the dimensions are a 0.020 inch cut with a 0.007 inch tie. Additional ties of a 1/32 inch width can be provided at key points to reduce the likelihood of unintended separation along the line of micro-perforations. The specific cut and tie dimensions will depend on the physical properties of the material, the perforation pattern, the overall strength (to prevent premature separation in desktop printers), ease of separation and appearance of the removable area after separation. Alternative example perforation dimensions are cut and tie dimensions of 0.013 inch/0.005 inch; 0.010 inch/0.005 inch; and 0.125 inch/0.09375 inch. Other forms of micro-perforations are disclosed in International Publication No. WO 99/51386, dated Oct. 14, 1999, which is entitled “Dynamic Laser Cutting Apparatus” and assigned to Avery Dennison Corporation of Pasadena, Calif., and hereby incorporated by reference in its entirety.

In the embodiment of FIG. 1, the lines of weakness divide the sheet into equally-sized printable sections 14. The sheet may be of any size, but is typically a standard-sized sheet, such as 8″ by 11.5″ or A4. The sheet may also be made of any printable material. In the embodiment of FIG. 1, light cardstock is preferred. For example, a one hundred pound text material, which is available from a variety of manufacturers, may be used. However, any of a wide variety of printable papers, films, foils, plastics, coated mylar, or other printable materials known in the art may be used.

The sheet may alternatively be a polymer-coated paper in which a sheet of paper is coated on either one or both sides with a polymer coating. The polymer coating, which can be comprised of a high, medium, or low density polyethylene, polypropylene, polyester, and/or other similar films, is coated onto the substrate surface to add strength and/or dimensional stability. The weight of these types of coated paper substrates can vary over a wide range, with weights in the range of about thirty to about one hundred pounds/ream being useful. In total, the final coated paper substrate may be comprised of between about 10% and about 40% by weight polymer. In one embodiment of a sheet that is coated on both sides, the quantity of polymer may be approximately evenly divided between the top and bottom surface of the sheet. The sheet may also be uncoated paper. The weight of the uncoated paper can also vary over a wide range. In one embodiment, the weight for text may be up to one hundred pounds/ream and up to sixty-five pounds/ream for cover.

Considering again the configuration of one embodiment of a sheet according to the present invention, the plurality of printable sections renders the sheet particularly adaptable. That is, the user may have a supply of sheets as shown in FIG. 1 loaded into a printer. At one time, the user may print a ticket or other document that has a particular dimension. The ticket or other document will occupy a certain number of the independent printable areas. To remove the ticket or other document, the user will separate only the sections bearing the printed ticket along the lines of weakness. Unprinted sections will be left behind on the sheet.

At another time, the user may print a second ticket of a different configuration or size on another of the sheets in the supply. This second ticket may occupy a different number of the printable sections on the sheet. After printing, the user again removes the printed sections from the sheet along the appropriate lines of weakness.

The adaptable nature of the embodiment of FIG. 1 arises from the plurality of different printable sections that have a relatively small size, such as two inch by two inch in one embodiment. Consequently, removable tickets of various shapes and sizes can be printed on the same sheet design. This is a significant improvement over sheets having no lines of weakness, and over sheets with only large-sized removable section, which are not adaptable to multiple ticket or document sizes and configurations.

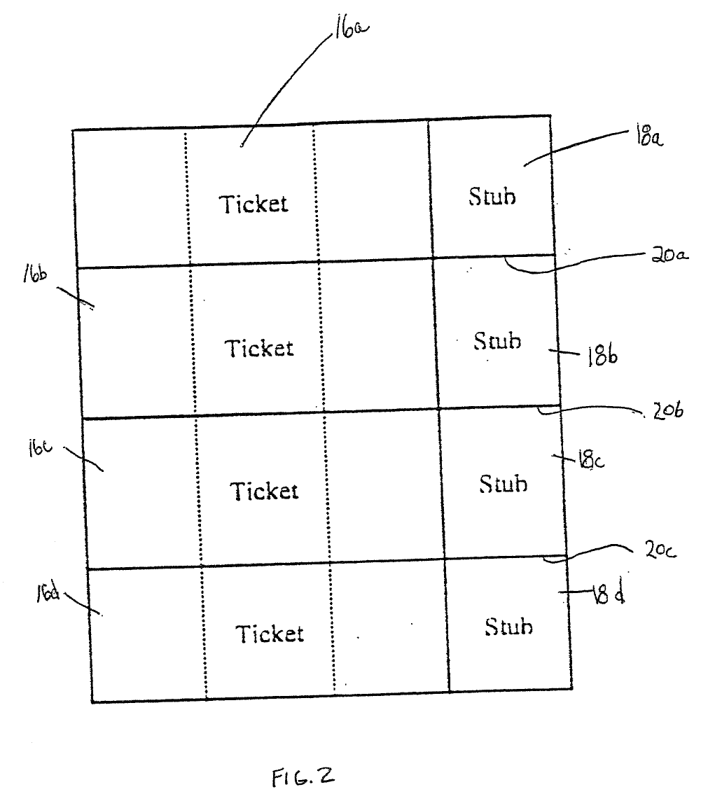

FIGS. 2-5 illustrate some specific examples of ticket and/or document configurations that can be printed on the adaptable universal media of FIG. 1. FIG. 2 illustrates the layout of the sheet of FIG. 1 when it is used to print several tickets and associated ticket stubs. In FIG. 2, four tickets with ticket stubs have been printed widthwise across the sheet. The “ticket” portion of each ticket occupies several sections, while the “stub” occupies a single section. After printing, the user will separate the individual tickets from one another along lines of weakness 20a-d, to form four separate ticket/stub combinations.

At the venue where the ticket is redeemed, the ticket taker keeps the “ticket” portion, but returns the “stub” to the user. The “stub” may be printed with specific useful information, such as a seat number, may be used as a souvenir of the event, and/or be a printed coupon for the purchase of some item, such as popcorn.

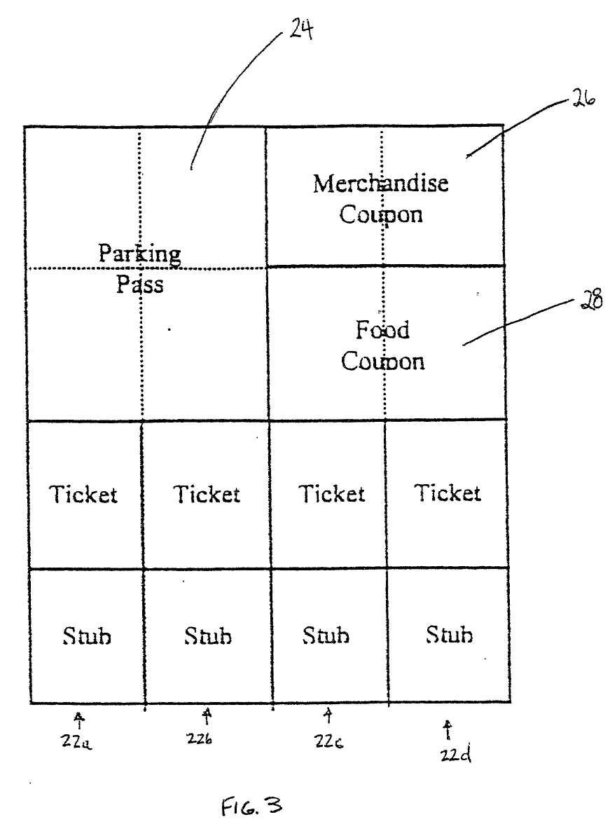

The arrangement of FIG. 3 is more complex. Ticket and stub combinations 22a-d are printed in the lower half of the sheet. The upper half of the sheet is printed with a parking pass 24, a merchandise coupon 26 and a food coupon 28. The arrangement of FIG. 3 may be considered a “family pack” type of ticket, in which tickets are provided for each member of the family, and with a parking pass provided for the family automobile. The merchandise coupon may be used to obtain a discount on merchandise at the venue or elsewhere, and the food coupon may be redeemed at the venue for free or discounted food items. It should be noted that the complex arrangement of FIG. 3 is rather different than the multi-ticket arrangement of FIG. 2, although the same adaptable universal sheet of FIG. 1 is used to print both arrangements.

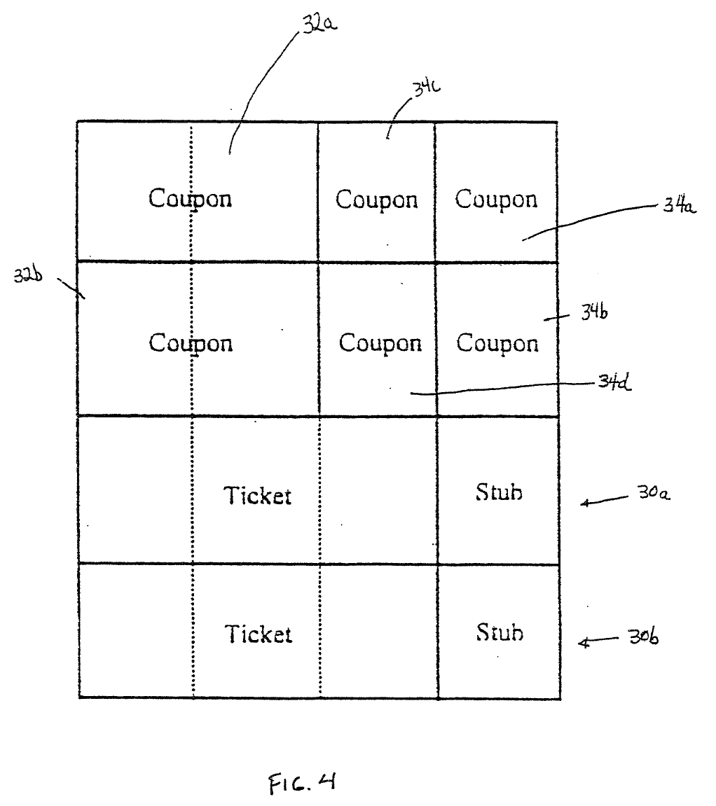

FIG. 4 illustrates a further embodiment, in which two ticket/stub combinations 30a,b extend width-wise across the bottom half of the sheet, and a variety of coupons are printed in the upper half of the sheet. The coupons are of different sizes. The two coupons 30a,b on the upper left-hand side of the sheet occupy two printable sections of the sheet each. The four other coupons 34a-d, on the upper right-hand side of the sheet, each occupy one printable section of the sheet. This again illustrates the adaptable nature of the perforated sheet, in that the user and/or printing software may print text and/or graphics on any desired number of the printable areas on the sheet.

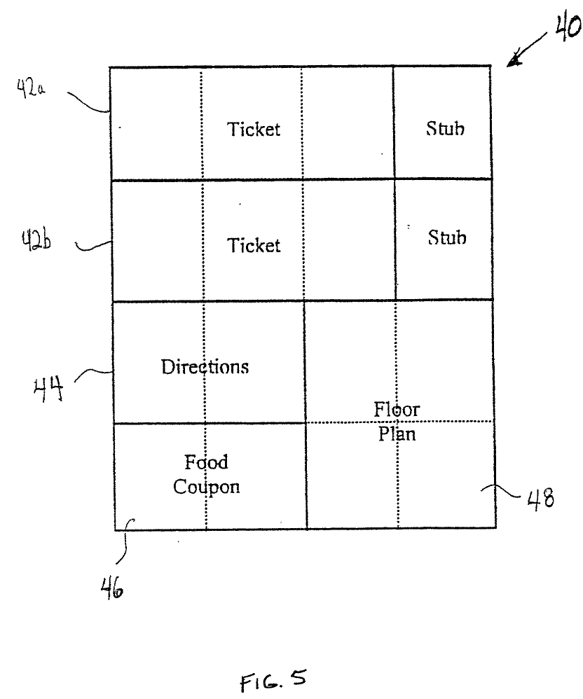

FIG. 5 illustrates an embodiment of a sheet 40 having printable ticket areas 42a,b, an area for printing directions to the event 44, a food coupon 46 and a floor plan 48 of the event area.

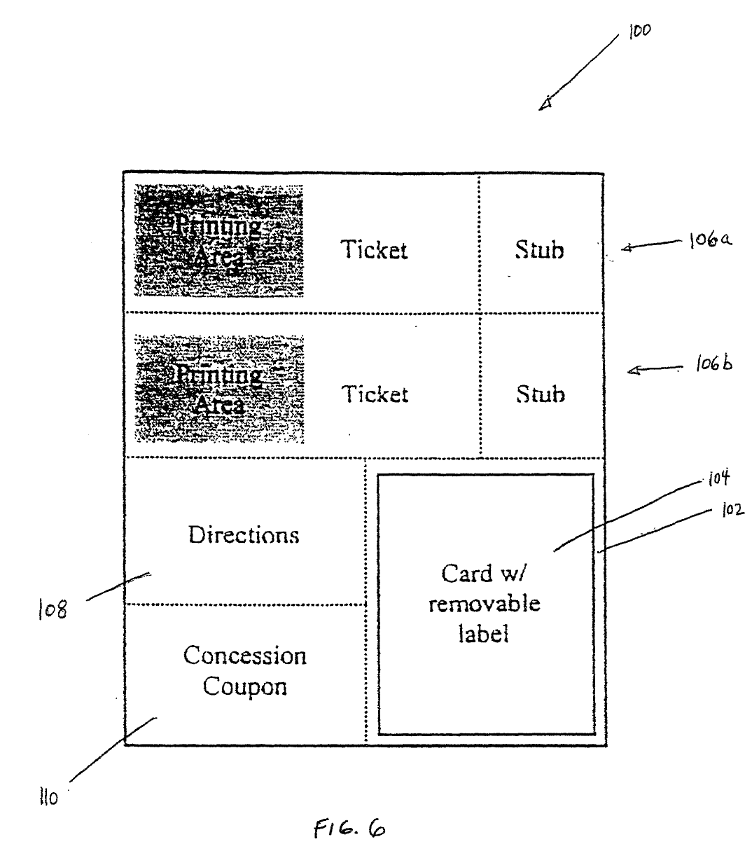

Other embodiments of the present invention relate to specific sheet configurations that are particularly well-adapted for printing specific types of documents, such as event tickets, gift certificates and greeting cards. FIG. 6 illustrates an embodiment 100 in which a card 102 with a removable label 104 is provided on a portion of the sheet, with other printable areas on other locations on the sheet. A card area is defined in the lower left hand portion of the sheet. A removable label 104, comprising a facestock that is coated with a pressure sensitive adhesive, is provided on the card. The card may be coated with a release coating, such as silicone, for easy removal of the sticker. Alternatively, the adhesive may be selected such that no release coating is necessary to remove the label from the card after printing. An example of a sheet structure having a removable label that is removable even without the use of a release coating is described in Avery Dennison U.S. Pat. No. 5,316,344, issued May 31, 1994 and entitled “Stationary With Removable Printable Labels And Method Therefor,” which is incorporated by reference.

The assembly also includes areas 106a,b for printing ticket and stub combinations, as well as areas for printing driving directions 108 and concession coupons 110. The card/label combination and the other printable areas are separated from one another by lines of weakness, such that each printable area is independently removable from the sheet.

The card with the removable label may be used for a variety of purposes. One use is to print an appealing graphic on the label, such as a dinosaur or other image, that is particularly appealing to children. The label may be related thematically to the event for which the ticket and stub are printed, and may serve as a momento of the event. If the tickets are for a dinosaur-themed movie, for example, the sticker may be printed with an image of a dinosaur. A child may then apply the dinosaur sticker to a notebook or other surface.

In an alternative embodiment, the label may fill less than the entire surface area of the card, so that there is printable area on the card itself that remains even after the sticker is removed. As a further alternative, the card can be provided without a sticker at all, such that the card is a removable, stand-alone card. This arrangement may be desirable for the purpose of printing a trading card that is related to the theme of the ticketed event. Tickets for a baseball game, for example, may be accompanied by a printed baseball card. The user may have the option to print an image of a particular player, for example, when purchasing and printing a ticket online. In this way, the card is provided as a bonus when the ticket is purchased and printed.

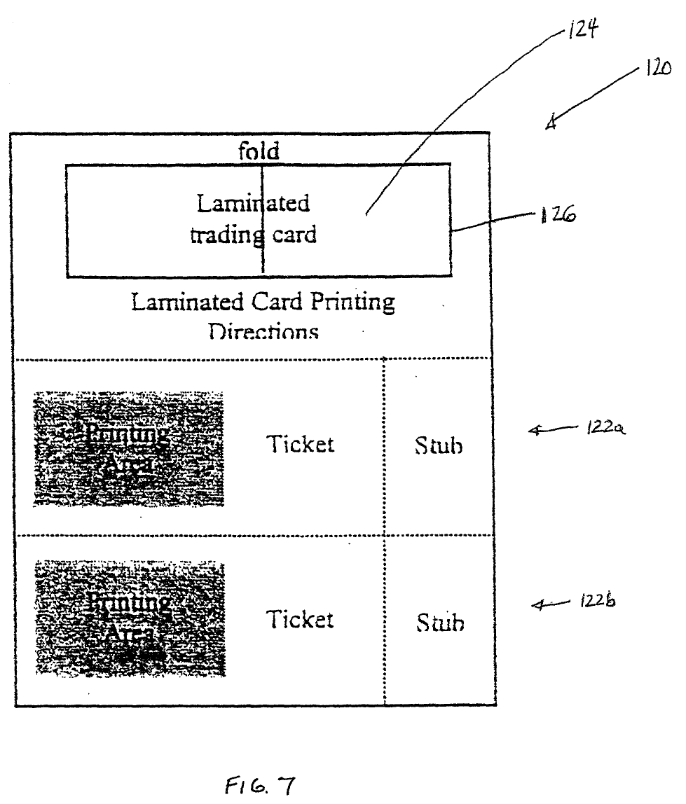

Turning now to the embodiment of FIG. 7, an assembly 120 is provided that will permit the user to print ticket and stub combinations 122a,b, as well as to print a laminated trading card 124 or other type of laminated object. Assemblies for printing and forming laminated objects are disclosed in U.S. Pat. No. 5,662,976 entitled “Laminated Card Assembly” and granted on Sep. 2, 1997, which is incorporated by reference herein. As described in the foregoing patent, the portion of the structure for printing and forming a laminated object typically includes a face sheet that is die cut 126 to form a card or other shape. A sheet of lamination is adhered on the non-printing side of the face sheet, and is also die cut or otherwise provided with lines of weakness. After the user prints the printing surface of the card, the user may punch the printed card and the die cut portion of the lamination member from the sheet. The lamination member, which is larger than the card and is typically provided with a fold line, is then folded over the printed surface of the card to laminate the card.

Further details of sheet structures with lamination members are provided in the above-referenced patents.

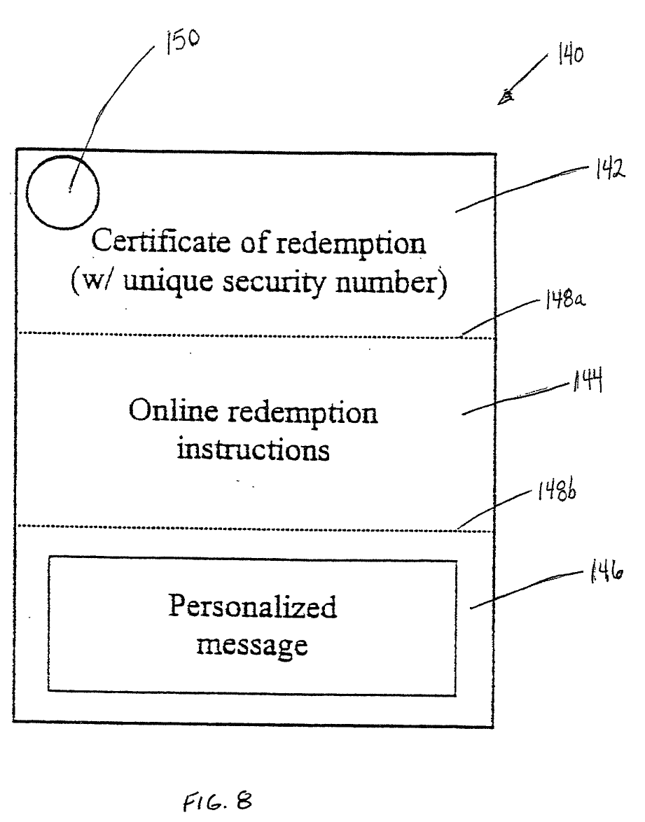

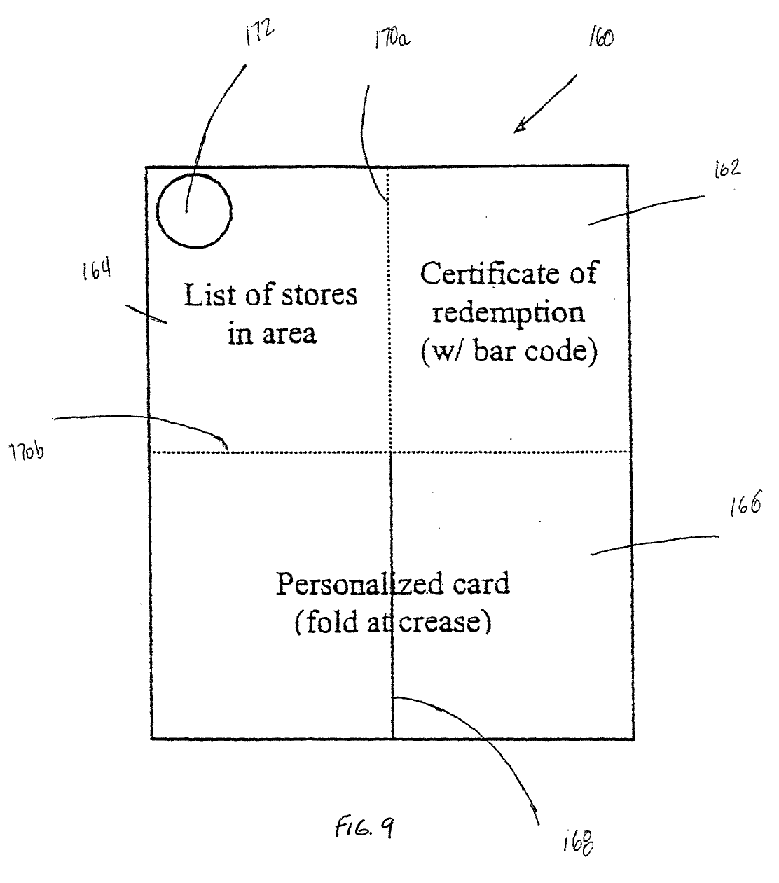

Considering now further embodiments of the invention, FIGS. 8 and 9 refer to particular sheet designs for printing gift certificates and related information. FIG. 8 illustrates an embodiment 140 having an area for printing a gift certificate 142 or other certificate of redemption, another area for printing redemption instructions 144, and another area 146 for printing a personalized message. The three areas are separated by lines of weakness 148a,b, such as perforations or micro-perforations or other types of lines of weakness known in the art.

The gift certificate 142 or certificate of redemption is typically authenticated by any of a number of known document authentication methods, such as bar codes, glyphs, serial numbers, special printed patterns, and the like. Any document authentication method known in the art and printable by a home or office computer may be used.

The embodiment of FIG. 8 may also include a removable envelope seal 150. The envelope seal is provided as a removable label. The underlying printable sheet may include an area of release coating beneath the label, or the adhesive may be selected so that no release coating is necessary, as described in Avery Dennison U.S. Pat. No. 5,316,344, the entire contents of which are hereby incorporated by reference. The user will typically print custom text and/or graphics onto the label and onto the different printable sections of the assembly during the printing step. The user then separates the certificate of redemption, the online redemption instructions and the personalized message sections from one another along the respective lines of weakness 148a,b. The user also removes the printed label from the sheet, places the three sections into an envelope, and then seals the envelope with the printed label.

In an alternative embodiment, the certificate of redemption, the online redemption instructions and the personalized message sections are separated by fold lines, and the whole sheet is folded after printing and the sections are not separated from one another.

FIG. 9 illustrates a further embodiment of a sheet 160 for printing a gift certificate and related information. An area for printing a gift certificate 162 is provided on a portion of the sheet. An adjacent printable section is provided for printing a list of stores 164 in a particular geographic area at which the recipient can redeem the gift certificate. The bottom portion of the assembly is a printable area 166 that defines a foldable greeting card. The card is provided with a fold line 168 that allows the user to fold the card after printing. The card is separated from the two other printable areas by lines of weakness 170a,b, such that the card may be removed from the rest of the assembly after printing and folded into a greeting card. The sheet 160 may also be provided with a removable envelope seal 162 or another removable label.

It should be noted at this point that the various embodiments of the invention are typically entirely blank prior to printing. However, in alternative embodiments of the invention, the sheet may be pre-printed in certain areas, with other areas being blank to receive further printing. It should also be noted that in the preferred method of printing the sheets, the user prints onto the sheets using a standard home or office printer, such as an ink jet or laser printer, or other home or office printer known in the art. The printer is typically connected to a personal computer or to a computer network. The user prepares the text and/or graphics to be printed on the sheet using computer software that is typically resident on a stand-alone personal computer, on a network server, or on another computer to which the user has access via a computer network or direct link.

One method of composing and printing documents using a personal computer and a computer network is described in detail in U.S. patent application Ser. No. 09/912,188, which was filed on Jul. 24, 2001 and which is incorporated by reference herein in its entirety. The methods of that patent application may be used to generate and print the tickets and other printed areas of the various embodiments described in this patent application.

One approach to generating a ticket and other textual and/or graphic matter to be printed onto customized media of the present invention utilizes an efficient method for generating and printing customized documents in a system having a client communicable with a network and a server communicable with the network. An interactive form is displayed on the client. User information is entered onto the interactive form, and is transmitted from the client to the server over the network. Default document parameters are obtained from a template file that is stored on the server or on a storage device that the server can access. Instructions to a page description file builder are formulated based upon the default document parameters and the user-defined information. A page description file is built based upon the instructions, and the page description file is transmitted to the client. The page description file is rendered for the first time at the client. One suitable type of page description file is a Portable Document Format (PDF) file, that can be rendered with standard software such as ADOBE ACROBAT READER.

In this approach, the user inputs certain information in an interactive form. For example, someone purchasing an event ticket may input their name, address, and billing information. They may also input other information, such as the title, date and time of the event, desired seat location, and/or other information related to the ticket. The user may also input certain information relating to the non-ticket portions of the sheet. For example, in an embodiment in which an event ticket and trading card are printed on the same media, the user may input information pertaining to the trading card, such as the name of a player or other information pertaining to the card to be printed.

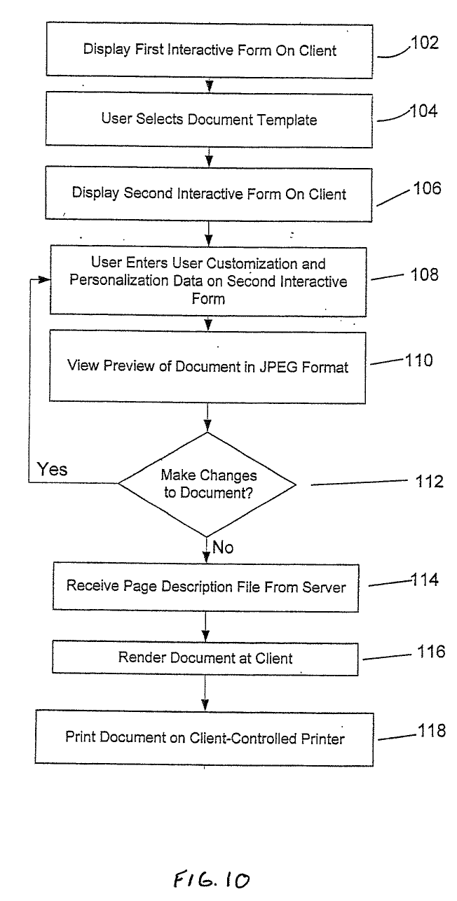

FIG. 10 illustrates the process of creating a customized and/or personalized document from the user's perspective. The process begins when a server transmits an interactive form, which is displayed on a display device at the client in step 102. The interactive form may be displayed as part of a web page. The interactive form may include a list of different document types from which the user may choose by clicking on a particular document type. For example, a list of various different types may be displayed on the monitor of a client in Step 102. These may include tickets, gift certificates, business cards, greeting cards, notes and other printed types of media.

At Step 104, the user clicks on one of the various document types to specify the type of document that the user wishes to generate. The various types of interactive forms are well known in the art, and include such features as blanks into which the user may type a particular desired type of document, pull-down menus, buttons on which the user can click with a mouse, and other standard web page features.

Once the user has selected a particular document type in Step 104, the server transmits a second interactive form to the client. The second interactive form asks the user to enter particular information appropriate to the document type that the user has selected. When the interactive form is displayed on the client (Step 106) the user then enters particular information onto the second interactive form in order to customize and personalize the document. This step is illustrated at Step 108 in FIG. 10. Where the document is an event ticket, for example, the user may enter information such as name, address, billing information, title of the event, date and time of the event, desired seat location, and/or other information related to the ticket. The user may also input certain information relating to the non-ticket portions of the sheet. For example where an event ticket and trading card are printed on the same media, the user may input information pertaining to the trading card, such as the name of a player or other information pertaining to the card to be printed.

It should be noted that in some embodiments of the invention, restrictions will be placed on what document defaults the user will be permitted to override. So, for example, in some embodiments the user will be permitted to change the font, but not the font size or color. Which particular default parameters the user will be permitted to change will depend on the desired characteristics of the system for a particular application or type of document. The invention is quite flexible in this regard, and encompasses systems that provide the user with a wide range of customization and personalization options, to systems that provide the user with no such options at all, as when another computer transmits data to the server for formulation into a page description file without the user providing customization and/or personalization information to the server.

At Step 110, the user has submitted the customization and personalization information to the server. Upon receiving the customization and personalization information, the server then generates a preview version of the document. In one particular embodiment of the invention, the preview version of the document to be printed is a quickly generated graphical image that may be in a relatively low-resolution format, such as a low-resolution Joint Photographic Experts Group (JPEG) format, progressive JPEG, GIF, interlaced GIF or other formats.

After viewing the preview version of the image, the user may wish to modify certain aspects of the document. Consequently, the user may reenter customization and/or personalization information, as desired, on the second interactive form. The user may reenter the customization and/or personal information as often as he or she likes, and may preview the revised version over and over again as changes are made. When the user is satisfied with the preview image of the document, the user indicates to the server that the user is satisfied with the customization and personalization information. The software on the server then generates a high quality final version of the document to be printed. This high quality version of the document to be printed may be a PDF file, which is transmitted from the server to the client at Step 114.

When the client has received the page description file, the client then renders a graphic based on the page description file at the client. This step of rendering the page description file 116 may be accomplished with standard graphic rendering software, such as ADOBE ACROBAT READER. Alternatively, another standard graphic rendering software that is compatible with the type of file that the server has generated may be used.

In one embodiment of the invention, the page description file is a Portable Document Format (PDF) file, but it can alternatively be in other formats, such as versions of Encapsulated Postscript (EPS), or a variety of other formats. As used herein, the term “page description file” preferably refers to a file, such as a PDF file, that describes a page in terms of text, embedded bitmap images, and/or the like. A page description file is different than bit-mapped, raster image file formats such as a BMP, Graphics Interchange Format (GIF), Tag Image File Format (TIFF), or PCX. As opposed to those bit-mapped file formats, which result in relatively large file sizes, a page description file instead provides a graphic rendering program (such as ADOBE ACROBAT READER) with the information needed to render a graphic, typically without providing specific information for every individual bit or pixel of a display space. Consequently, a page description file is usually more compact than a bit-mapped file, and is better suited for transmission over a network.

Once the client has graphically rendered the document at Step 116 using the page description file, the user then has the option at Step 118 of printing the rendered document at a client controlled printer, such as a desktop printer.

It should be understood that the present method of generating and printing customized and personalized documents may be accomplished with various additional steps, or with fewer steps. For example, the step of previewing the graphic before final generation and printing of the graphic can be omitted. That is, once the user has entered his or her customization and personalization data, the user does not necessarily need to preview what the document will look like prior to the final page description file being constructed.

To this point, the discussion of the present invention has been directed primarily toward the perspective of the end user, who uses the client to define and ultimately print customized and personalized documents. However, an important aspect of one embodiment of the present invention is that the system generates the final page description file in a particularly efficient manner. That is, as compared to prior art methods in which the server itself graphically renders the document prior to transforming the graphic into a page description file to be sent to the client, the preferred embodiment of the present invention never renders a graphic on the server. Rather, software on the server simply generates a set of instructions to other software that builds the page description file.

By building the page description file on the server without rendering the file and instead rendering the graphic for the first time on the client, the present method saves substantial computing time at the server level. The server is thus much less likely to become bogged down by simultaneous requests from multiple users, and the capacity of the server increases. Consequently, the back-end operations of the present invention are of particular importance to the efficiency of the preferred embodiment of the present invention.

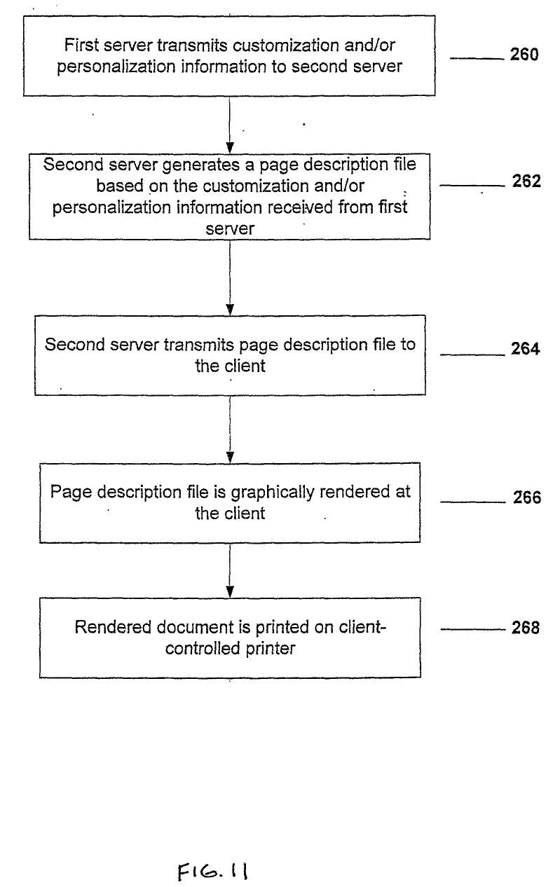

FIG. 11 represents a method in which customization and/or personalization information is not transmitted from the end user to the server, but is transferred from a first server to a second server. At Step 260, a first server transmits customization and/or personalization information to the second server. The information may be prestored on the first server as, for example, information that the user has previously stored on the first server, or information that the first server has itself generated. The second server then generates a page description file at Step 262, based on the customization and/or personalization information received from the first server. The second server transmits the page description file to the client at Step 264, and the page description is graphically rendered for the first time, at the client, in Step 266. The rendered document may then be printed at a client-controlled printer in Step 268

Consequently, the present invention is not limited to systems in which a user enters the customization and/or personalization information at the client and then transmits that information from the client to the server. The information transmitted to the server may even be generated in real time as, for example, data from a testing device, real-time sports scores, weather data, or an almost infinite variety of different types of data that can be represented graphically in some fashion. As a further alternative, the data provided to the server may be data files or data drawn from data files, such as data files for personal organization software or a variety of other programs that may be resident on a client or server. The data may also be stored in and drawn from a database.

The present invention is also not limited to generating page description files on the server, but also encompasses generating bit-mapped graphic files and transmitting them elsewhere. However, the graphic file is preferably not rendered on the server, but is first rendered at the client or at another site after the server has generated the file. In this manner, the server does not become engaged in the resource-intensive process of rendering a graphic file. Software for building graphic files is known in the art.

The user-entered information is transmitted from the client to the server over the network. The server then obtains default document parameters from a template file that is stored on the server or on a storage device that the server can access. The template file is selected to correspond to the particular media onto which the graphics and text is ultimately to be printed. The template file includes default values corresponding to the size and layout of the particular sheet to be printed, default fonts, font sizes, colors to be printed, and/or default graphics and/or text to be printed. Instructions to a page description file builder are formulated based upon the default document parameters from the template file and the information that the user defined at the client. The instructions to the page description file builder may also include document identification information, such as a particular ticket number or security code to be printed onto the ticket. Methods for sequentially generating a ticket number or for generating a security code or other unique identifying information, such as a glyph, are known in the art.

Once the page description file is generated, it is transmitted to the client. The page description file may be transmitted to the client by any of a number of ways, including via e-mail, via File Transfer Protocol (FTP) or any method for transferring a file from a server to a client. The client then renders the page description file as, for example, by rendering a PDF file with ADOBE ACROBAT READER. The rendered image is then printed onto specialized media, of the type illustrated in FIGS. 1-9.

It should be understood that the foregoing efficient method of generating and printing documents may be varied in a number of ways. The ultimate destination of the printable page description file need not be to the client or to a client-controlled printer. For example, the server may transmit the final printable page description file to the client for printing on a client-controlled printer. However, the server may alternatively send the printable page description file to a location other than the client, such as to a commercial printing facility and/or a printing press. The server may alternatively send the page description file via e-mail to an e-mail address or via FTP (File Transfer Protocol) to an FTP address. The user may specify the e-mail or FTP address to which the file should be sent, or the e-mail or FTP address may be stored in a directory on the server, such as a directory of commercial printing facilities. Numerous other variations are possible.

The reader is directed to U.S. Provisional Patent Application Serial No. 60/201,234 for further information concerning suitable methods for generating files that can be printed onto particular media. Other methods for generating and printing customized and/or personalized documents are known in the art, and may be used in conjunction with the present invention.

It is noted that in the various embodiments, the entire surface of the sheet need not be printable. Portions of the sheet may be pre-printed, or coated with coatings that are not receptive to printing. However, at least one or more predefined printable areas are provided on the sheet, to receive printing. For example, on an embodiment configured for printing a ticket to a baseball game, portions of the ticket may be preprinted with baseball-related images, with at least one blank area provided somewhere on the ticket to receive printing from the desktop printer.

It should be understood that while the foregoing describes particular embodiments of the invention, various changes and modifications may be made within the scope of the invention. The particular sheet designs illustrated in FIGS. 1-9 are presented as examples, and numerous other sheet layouts may be imagined. It is contemplated that the media will typically include a paper or cardstock sheet, but various other materials may be used, including printable plastics and other media typically used for printable labels. Various types of printers may be used to print tickets and/or other documents onto the media. While ink jet printers and laser printers are the most common, other printers such as dot matrix and thermal printers, as well as a variety of commercial printers, may be used.

The printable sheet may also be of the type that is first folded flat then, after some time in storage, may be unfolded and reliably printed. Examples of such printable sheets may be found in U.S. Pat. No. 6,136,130, entitled “High Strength, Flexible, Foldable Printable Sheet Technique”, issued on Oct. 24, 2000 and hereby incorporated by reference.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, different sizes of media having different sizes of perforated sections may be used with the present invention. Additionally, many different types of documents can be printed using the present invention, in addition to tickets and gift certificates. It is therefore intended that the scope of the invention be limited not by this detailed description.

I claim:

1. A method of printing an event ticket comprising the steps of:
purchasing a plurality of tickets across a computer network; and
printing the plurality of tickets using a desktop printer onto a media having a plurality of ticket printing areas each defined on at least one edge by a line of weakness, the plurality of ticket printing areas configured to allow tickets of different sizes and for different events to be printed on the media.

2. The method of claim 1, wherein purchasing a ticket across a computer network includes:
providing ticket selection information across the network from a computer; and
transmitting ticket printing information across the network to the computer.

3. The method of claim 1, wherein the step of printing the ticket includes printing a unique identifier on the media to authenticate the ticket.

4. The method of claim 3, wherein the unique identifier is at least one of a bar code, alphanumeric printed text or a glyph.

5. The method of claim 1, wherein the desktop printer is attached to a personal computer that is a client in a client-server network.

6. The method of claim 1, wherein each of the plurality of ticket printing areas includes a removable ticket stub area.

7. The method of claim 6, further comprising the step of printing a ticket stub onto the removable ticket stub area.

8. The method of claim 1, further comprising printing directions on the media.

9. The method of claim 1, further comprising printing at least one concession coupon onto an additional removable portion of the media.

10. The method of claim 1, further comprising printing indicia onto a removable label positioned on said media.

11. The method of claim 1, wherein the media includes a card area having at least one printing surface and a lamination member attached to the media and adapted to laminate the card area, the method further comprising printing onto the card area.

12. The method of claim 1, further comprising printing a parking pass onto a removable portion of the media.

13. A method of printing an event ticket comprising:
purchasing a ticket across a computer network; and
printing the ticket using a desktop printer onto a media, the media having a plurality of ticket printing areas each defined on at least one edge by a line of weakness, wherein a ticket is printed on at least one of said plurality of ticket printing areas.

14. The method of claim 13, wherein each of the plurality of ticket printing areas including a removable ticket stub area.

15. The method of claim 14, further comprising printing a ticket stub onto the removable ticket stub area.

16. The method of claim 13, wherein the media further includes a removable ticket stub area.

17. The method of claim 13, wherein purchasing a ticket across a computer network includes:
providing ticket selection information across the network from a computer; and
transmitting ticket printing information across the network to the computer.

18. The method of claim 13, wherein printing a ticket includes printing a unique identifier on the media to authenticate the ticket.

19. The method of claim 18, wherein the unique identifier is at least one of a bar code, alphanumeric printed text or a glyph.

20. The method of claim 13, wherein the desktop printer is attached to a personal computer that is a client in a client-server network.

21. The method of claim 13, further comprising printing directions on the media.

22. The method of claim 13, further comprising printing at least one concession coupon onto an additional removable portion of the media.

23. The method of claim 13, further comprising printing indicia onto a removable label positioned on the media.

24. The method of claim 13, wherein the media includes a card area including at least one printing surface and a lamination member attached to the media and adapted to laminate the card area, the method further comprising printing onto the card area.

25. The method of claim 13, further comprising printing a parking pass onto a removable portion of the media.

26. The method of claim 13, further comprising printing a plurality of tickets onto the media.

27. A media for the printing of an event ticket over a desktop printer, the media comprising:
a plurality of pre-defined ticket printing areas each having a line of weakness along at least one edge, the plurality of pre-defined ticket printing areas for printing at least one event ticket from said desktop printer.

28. The media of claim 27, wherein each of the plurality of ticket printing areas includes a removable ticket stub printing area.

29. The media of claim 27, wherein the media includes an additional, predefined printing area for printing an event parking pass.

30. The media of claim 27, wherein the media includes an additional, predefined printing area for printing at least one event discount coupon.

31. The media of claim 27, wherein the media includes an additional, predefined printing area for printing a removable label.

32. The media of claim 27, wherein the media includes an additional, predefined printing area for printing directions to an event.

33. The media of claim 27, wherein the media includes an additional, predefined printing area for printing a floor plan of an event.

34. The media of claim 27, wherein the media includes an additional, predefined printing area for printing a trading card.

35. The media of claim 27, wherein the media includes an additional, predefined printing area for printing a personalized message.

36. The media of claim 27, wherein the media includes an additional, predefined printing area for printing a unique identifier on the media to authenticate the ticket.

37. The media of claim 27, wherein the media includes a removable adhesive portion, the media being foldable into an envelop e and sealable with the removable adhesive portion.

38. A method of presenting an event ticket comprising:
purchasing a ticket across a computer network;
printing the ticket using a desktop printer onto a media, the media having a plurality of ticket printing areas each defined on at least one edge by a line of weakness, wherein a ticket is printed on at least one of said plurality of ticket printing areas;
removing the ticket from the media;
presenting the ticket for verification at an event; and
removing the ticket stub from the ticket.

39. The method of claim 38, wherein each of the plurality of ticket printing areas includes a removable ticket stub area.

40. The method of claim 39, further comprising printing a ticket stub onto the removable ticket stub area.

41. The method of claim 38, wherein the media further includes a removable ticket stub area.

42. The method of claim 38, wherein purchasing a ticket across a computer network includes:
providing ticket selection information across the network from a computer; and
transmitting ticket printing information across the network to the computer.

43. The method of claim 38, wherein printing a ticket includes printing a unique identifier on the media to authenticate the ticket.

44. The method of claim 43, wherein the unique identifier is at least one of a bar code, alphanumeric printed text or a glyph.

45. The method of claim 38, wherein the desktop printer is attached to a personal computer that is a client in a client-server network.

46. The method of claim 38, further comprising printing directions on the media.

47. The method of claim 38, further comprising printing a concession coupon onto an additional removable portion of the media.

48. The method of claim 38, further comprising printing indicia onto a removable label positioned on said media.

49. The method of claim 38, wherein the media includes a card area including at least one printing surface and a lamination member attached to the media and adapted to laminate the card area, the method further comprising printing onto the card area.

50. The method of claim 38, further comprising printing a parking pass onto a removable portion of the media.

51. The method of claim 38, further comprising printing a plurality of tickets onto the media.

52. A method of printing an event ticket on a desktop printer, comprising:
purchasing a ticket across a computer network; and
printing the ticket using a desktop printer, wherein printing the ticket on a desktop printer comprises printing the ticket onto a media having a ticket printing area defined on at least one edge by a line of weakness.

53. The method of claim 52, wherein purchasing a ticket across a computer network includes:
providing ticket selection information across the network from a computer; and
transmitting ticket printing information across the network to the computer.

54. The method of claim 52, wherein printing the ticket includes printing a unique identifier on the media to authenticate the ticket.

55. The method of claim 54, wherein the unique identifier is at least one of a bar code, alphanumeric printed text or a glyph.

56. The method of claim 52, wherein said desktop printer is attached to a personal computer that is a client in a client-server network.

57. The method of claim 52, wherein the media includes a removable ticket stub area, the method further including printing a ticket stub onto the ticket stub area.

58. The method of claim 52, further comprising printing directions on the media.

59. The method of claim 52, further comprising printing a concession coupon onto a removable portion of the media.

60. The method of claim 52, wherein the media includes a removable label, and the method further includes printing onto the removable label.

61. The method of claim 52, wherein the media includes a card area having at least one printing surface and a lamination member attached to the media and adapted to laminate the card area, the method further comprising printing onto the card area.

62. The method of claim 52, further comprising printing a parking pass onto a removable portion of the media.

63. The method of claim 52, further comprising printing a plurality of tickets onto the media.

64. A method of printing a gift certificate on a desktop printer, comprising:
purchasing a gift certificate across a computer network; and
printing the gift certificate using a desktop printer, wherein printing the gift certificate on a desktop printer comprises printing the gift certificate onto a media having a certificate printing area defined on at least one edge by a line of weakness.

65. The method of claim 64, wherein purchasing a gift certificate across a computer network includes:
providing gift certificate selection information across the network from a computer; and
transmitting gift certificate printing information across the network to the computer.

66. The method of claim 64, wherein printing the gift certificate includes printing a unique identifier on the media to authenticate the gift certificate.

67. The method of claim 66, wherein the unique identifier is one of the group constituting: a bar code, alphanumeric printed text, and a glyph.

68. The method of claim 64, wherein said desktop printer is attached to a personal computer that is a client in a client-server network.

69. The method of claim 64, further comprising printing gift certificate redemption instructions on the media.

70. The method of claim 64, further comprising printing a personalized message on a portion of the media.

71. The method of claim 64, wherein the media includes a removable card area having a fold line and the method includes printing onto the card area.

72. The method of claim 64, wherein the media includes a removable envelope seal.

73. The method of claim 64, further comprising printing a list of stores in a particular local on a removable portion of the media.

74. A method of printing a certificate purchased online, comprising:
purchasing at least one certificate across a computer network; and
printing the certificate using a desktop printer, wherein printing the ticket on a desktop printer comprises printing the certificate onto a media sheet having a plurality of separate printing areas separated by lines of weakness.

75. The method of claim 74, wherein the plurality of separate printing areas includes equally-sized printing areas separated into rows and columns by lines of weakness.

76. The method of claim 75, wherein the separate printing areas are no larger than one inch by one inch.

77. The method of claim 74, further comprises printing a ticket on at least one of said printing areas, and printing a ticket stub on an adjacent one of said printing areas.

78. The method of claim 74, wherein said certificate is one or more of the group constituting a ticket, directions, a food coupon, a parking pass and a merchandise coupon.

79. The method of claim 74, further comprising:
loading a supply of media sheets each comprising a plurality of separate printing areas separated into rows and columns by lines of weakness;
printing a first document onto a first media sheet, in which said first document is printed onto particular rows and columns of said first media sheet; and
printing a second document onto a second media sheet, in which said second document is printed onto particular rows and columns of said second media sheet, said printed rows and columns of said second media sheet being different than said printed rows and columns of said first media sheet.
